(19) United States
(12) Patent Application Publication
(10) Pub. No.: US 2021/0007351 A1
(43) Pub. Date: Jan. 14, 2021

(54) PESTICIDE

(71) Applicant: M H Poskitt Limited, Goole (GB)

(72) Inventor: Christopher James Bramley, Goole (GB)

(21) Appl. No.: 16/981,893

(22) PCT Filed: Mar. 19, 2019
(86) PCT No.: PCT/GB2019/050764

§ 371 Date: Sep. 17, 2020

(30) Foreign Application Priority Data
Mar. 19, 2018 (GB) 1804357.0

(51) Int. Cl. A01N 31/16; A01N 31/06; A01N 31/04; A01N 65/12

(52) U.S. Cl. CPC A01N 31/16; A01N 65/12; A01N 31/04; A01N 31/06

(57) ABSTRACT

Provided are materials and methods for preventing or inhibiting the growth of and/or killing a plant pathogen of the genus Phytophthora on a plant (or on a foodstuff derived from said plant).

### FIELD OF THE INVENTION

The invention relates to pesticides, more particularly to an extract from Artemisia and its use as an anti-oomycete, together with active compounds identified therein.

### BACKGROUND TO THE INVENTION

Phytophthora is a genus of oomycete, the majority (at least) of which are plant-pathogens, causing significant environmental and economic harm. Plants affected include crop plants. Of particular note, infection (‘late blight’) of crops of the solanaceous family by Phytophthora infestans causes serious problems.

Late blight infection in potatoes still remains one of the biggest challenges to potato farmers, even over 170 years after the disease resulted in a famine in Ireland—causing death and displacement of over 3 million people. Late blight can cause complete loss of the crop through leaf and tuber infection. Controlling late blight in potato is challenging not least given the vast area (about 120,000 ha in the UK) that is farmed for this crop. Generally, industry losses are relatively low, but this requires the use of intensive fungicide programmes costing £100-200/ha, sometimes involving 15 or more treatments in the season. Traditionally, Metalaxyl (costing £25/ha) has been used, but strains resistant to this active (and to other pesticides, e.g. fluazinam) have emerged. There remains the need for further, effective treatments for Phytophthora infection, ideally biologically-derived treatments that have the potential to offer alternatives that are cheaper and/or give rise to fewer environmental adverse effects.

It is amongst the objects of the present invention to attempt a solution to these problems.

### SUMMARY OF THE INVENTION

Provided is a method for preventing or inhibiting the growth of and/or killing a plant pathogen of the genus Phytophthora on a plant or on a foodstuff derived from said plant, said method comprising administering to said plant or said foodstuff one or more compounds selected from:
(i) Formula I, or an agriculturally acceptable salt thereof, or solvate, racemic mixture, enantiomer, diastereomer or tautomer thereof:

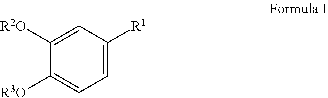

wherein:
R¹ is selected from the group consisting of H, substituted or unsubstituted C₁₋₆ alkyl, substituted or unsubstituted C₂₋₆ alkenyl, substituted or unsubstituted C₂₋₆ alkynyl, —C(═O)R⁴, and —(CH₂)ₙC(═O)R⁴;
R² and R³ are independently selected from the group consisting of H, substituted or unsubstituted C₁₋₁₀ alkyl, substituted or unsubstituted C₂₋₁₀ alkenyl, substituted or unsubstituted C₂₋₁₀ alkynyl, substituted or unsubstituted aryl ring, substituted or unsubstituted heterocyclic ring, —C(═O)R⁴, —(CH₂)ₙC(═O)R⁴, —C(═O)(CH₂)ₙR⁴, and —C(═O)NHR⁴;
R⁴ is selected from the group consisting of H, OR⁵, substituted or unsubstituted C₁₋₆ alkyl, substituted or unsubstituted C₂₋₆ alkenyl, substituted or unsubstituted C₂₋₆ alkynyl, substituted or unsubstituted aryl, and substituted or unsubstituted heterocyclic ring;
R⁵ is selected form the group consisting of H, substituted or unsubstituted C₁₋₆ alkyl, substituted or unsubstituted C₂₋₆ alkenyl, substituted or unsubstituted C₂₋₆ alkynyl, substituted or unsubstituted aryl, and substituted or unsubstituted heterocyclic ring; and
n is an integer from 1 to 6; or
(ii) Formula II, or an agriculturally acceptable salt thereof, or solvate, racemic mixture, enantiomer, diastereomer or tautomer thereof:

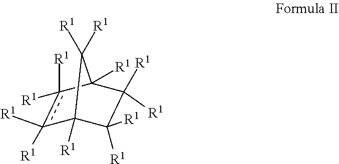

wherein:
each R¹ are independently selected from the group consisting of H, OR², substituted or unsubstituted C₁₋₆ alkyl, substituted or unsubstituted C₂₋₆ alkenyl, substituted or unsubstituted C₂₋₆ alkynyl, —C(═O)R³, —(CH₂)ₙC(═O)R³, —C(═O)(CH₂)ₙR³, and —C(═O)NHR³;
or any two R¹ attached to the same carbon form ═O;
or any two R¹ attached to the same carbon form a substituted or unsubstituted exocyclic C₂₋₆ alkenyl with the carbon atom to which they are attached;
R² is selected form the group consisting of H, substituted or unsubstituted C₁₋₆ alkyl, substituted or unsubstituted C₂₋₆ alkenyl, substituted or unsubstituted C₂₋₆ alkynyl, substituted or unsubstituted aryl, and substituted or unsubstituted heterocyclic ring;
R³ is selected from the group consisting of H, OR², substituted or unsubstituted C₁₋₆ alkyl, substituted or unsubstituted C₂₋₆ alkenyl, substituted or unsubstituted C₂₋₆ alkynyl, substituted or unsubstituted aryl, and substituted or unsubstituted heterocyclic ring;
---- represents an optional double bond; and
n is an integer from 1 to 6; or
(iii) Formula III, or an agriculturally acceptable salt thereof, or solvate, racemic mixture, enantiomer, diastereomer or tautomer thereof:

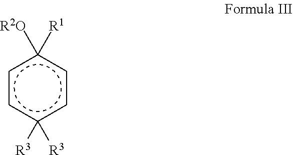

wherein:
R¹ is selected from the group consisting of H, substituted or unsubstituted C₁₋₆ alkyl, substituted or unsubstituted C₂₋₆ alkenyl, substituted or unsubstituted C₂₋₆ alkynyl, —C(═O)R⁴, and —(CH₂)ₙC(═O)R⁴;
or R¹ forms a substituted or unsubstituted exocyclic C₂₋₆ alkenyl with the carbon atom of the cyclohexyl ring to which it is attached and OR² is absent;
R² is selected from the group consisting of H, substituted or unsubstituted C₁₋₁₀ alkyl, substituted or unsubstituted C₂₋₁₀ alkenyl, substituted or unsubstituted C₂₋₁₀ alkynyl, substituted or unsubstituted aryl ring, substituted or unsubstituted heterocyclic ring, —C(═O)R⁴, —(CH₂)ₙC(═O)R⁴, —C(═O)(CH₂)ₙR⁴, and —C(═O)NHR⁴;
each R³ are independently selected from the group consisting of H, OR⁵, substituted or unsubstituted C₁₋₆ alkyl, substituted or unsubstituted C₂₋₆ alkenyl, substituted or unsubstituted C₂₋₆ alkynyl, —C(═O)R⁴, —(CH₂)ₙC(═O)R⁴, —C(═O)(CH₂)ₙR⁴, and —C(═O)NHR⁴;
or the two R³ together form an exocyclic substituted or unsubstituted C₂₋₆ alkenyl with the carbon atom to which they are attached;
R⁴ is selected from the group consisting of H, OR⁵, substituted or unsubstituted C₁₋₆ alkyl, substituted or unsubstituted C₂₋₆ alkenyl, substituted or unsubstituted C₂₋₆ alkynyl, substituted or unsubstituted aryl, and substituted or unsubstituted heterocyclic ring;
R⁵ is selected form the group consisting of H, substituted or unsubstituted C₁₋₆ alkyl, substituted or unsubstituted C₂₋₆ alkenyl, substituted or unsubstituted C₂₋₆ alkynyl, substituted or unsubstituted aryl, and substituted or unsubstituted heterocyclic ring;
---- represents an optional double bond between any two carbon atoms of the cyclohexyl ring;
where ----- is a double bond including the carbon substituted by R¹ and OR², either R¹ or OR² is absent;
where ----- is a double bond including the carbon substituted by R³ and R³, one R³ is absent; and
n is an integer from 1 to 6.

Preferably the method comprises administering to said plant or said foodstuff a compound of Formula I that is eugenol and/or a compound of Formula II that is exo, exo-2,3-camphanediol and/or a compound of Formula III that is terpineol.

Also provided is a method for preventing or inhibiting the growth of and/or killing a plant pathogen of the genus Phytophthora on a plant or on a foodstuff derived from said plant, said method comprising administering to said plant or said foodstuff a liquid extract from a plant of the genus Artemisia.

Preferably, said plant of the genus Artemisia is Artemisia vulgaris and/or said liquid extract is from a leaf and/or stem of said plant of the genus Artemisia and/or said liquid extract comprises water.

In any of such methods, said administering preferably comprises spraying the compound or liquid extract onto said plant or said foodstuff derived from said plant and/or the compound or liquid extract is administered to a plant in a field.

Preferably, said plant is a crop plant, preferably a food crop plant. The plant is preferably a plant of the Solanaceae family, such as a tomato plant or, preferably, a potato plant.

Also provided is use of a compound to prevent or inhibit the growth of and/or kill a plant pathogen of the genus Phytophthora on a plant or on a foodstuff derived from a plant, wherein said compound is one or more of compounds of Formula I, II and III as structurally defined above.

Also provided is use of a liquid extract from a plant of the genus Artemisia to prevent or inhibit the growth of and/or kill a plant pathogen of the genus Phytophthora on a plant or on a foodstuff derived from a plant.

Also provided is a composition comprising a compound and an agricultural spray adjuvant, wherein said compound is one or more of compounds of Formula I, II and III as structurally defined above.

Also provided is a composition comprising a liquid extract from a plant of the genus Artemisia and an agricultural spray adjuvant.

Preferably, said agricultural spray adjuvant comprises one or more of an oil, a surfactant, a sticker, and a penetrant.

### BRIEF DESCRIPTION OF THE DRAWING

The invention will be described with reference to the accompanying drawing, in which:

FIG. 1 shows P. infestans mycelial growth against various treatments.

### DETAILED DESCRIPTION OF THE INVENTION

### Extract and Method for the Preparation Thereof

Provided is a method for the preparation of a liquid extract from a plant of the genus Artemisia, said method comprising immersing material from said plant in a liquid and then collecting said liquid. Preferably, the plant is Artemisia vulgaris (known as common mugwort). The material may comprise material from any part(s) of the plant, including a root or flower or, preferably, a leaf and/or stem, preferably a leaf. The obtained extract can be consider to be a crude extract. Preferably, in the immersing step, plant material is used at a concentration of between 10 g and 1 kg, such as between 20 g and 500 g (e.g. 50 g and 400 g), for each litre of liquid.

Preferably, the immersing step has sufficient duration to enable one or more phytochemicals to move out from the plant material and into the liquid, in which any one or more of such phytochemicals might dissolve or suspend. The immersing step might for instance be at least 30 seconds long, preferably at least 1 min long, preferably at least 5 min long, such as at least 30 min long, e.g. at least 1 hr long, at least 6 hr long, at least 12 hr long or at least 24 hr long. The immersing step might for instance be no longer than 1 hr long, such as 6 hr or less, e.g. 12 hr or less, 24 hr or less, 48 hrs or less, or 7 days or less.

Preferably, said liquid comprises (or is) water. In this instance, the extract is an aqueous extract (potentially an aqueous solution). Preferably, the liquid (e.g. water) is heated before the plant material is added to it, e.g. to at least 30° C., to at least 40° C., to at least 50° C., to at least 60° C., to at least 70° C., to at least 80° C., to at least 90° C., or to at least 100° C.

Preferably, the method further comprises, before the immersing step, the step of comminuting the plant material. Comminution can involve more or more of e.g. crushing, grinding, cutting, ripping, shredding and shearing, and can take place in a blender or shredder.

The collecting step can involve removing the liquid from the plant material. This might involve sieving the liquid.

Optionally, after the collecting step, the plant material is pressed and the released liquid is added to the collected liquid. In addition, or alternatively, the collected liquid is concentrated and/or dried and/or filtered.

Preferably, the method further comprises, after the collecting step, the step of adding an agricultural spray adjuvant(s) to the (collected) liquid (i.e. to the liquid extract). The resultant product can also therefore be considered to be an (e.g. agricultural) composition comprising the extract and the agricultural spray adjuvant.

An agricultural spray adjuvant serves e.g. to improve the ability of the liquid extract (or other agricultural composition, or active compound therein) to act as a pesticide on a plant or plant-derived foodstuff, particularly once sprayed onto the plant/foodstuff. In particular, such an adjuvant (or collection of adjuvants) can serve to promote the activity and/or coverage and/or adhesion and/or absorption of the extract/composition in/on the plant or foodstuff following spray application. Such adjuvants might be known as activator adjuvants. Preferably the adjuvant(s) is non-phytotoxic.

Preferable adjuvants include or comprise:
an oil (“adjuvant oil”) e.g. a crop oil, a vegetable oil, a mineral oil, or a methylated seed oil to promote the activity of the extract/composition on the plant or foodstuff;
a surfactant (or “wetting agent” or “spreader”) to promote the coverage of the extract/composition on the plant or foodstuff; the surfactant can be anionic, cationic or, preferably, non-ionic;
a sticker (or sticking agent) to promote the adhesion of the extract/composition on the plant or foodstuff; the sticker can be or can comprise e.g. Latex based, terpene/pinolene based, or a pyrrolidone; and/or
a penetrant (or penetrating agent) to promote the absorption of the extract/composition into the plant or foodstuff; the penetrant can be or can comprise e.g. lecithin;

Particularly preferred is a combination of a surfactant and a sticker.

Provided is a liquid extract obtainable by a method according to any one of the above methods. In particular, provided therefore is a composition comprising a liquid extract from a plant of the genus Artemisia and an agricultural spray adjuvant (as detailed above).

### Methods for Tackling Phytophthora Infection

Provided is a method for preventing or inhibiting the growth of and/or killing a plant pathogen of the genus Phytophthora on a plant or on a foodstuff derived from said plant, said method comprising administering to said plant or said foodstuff (e.g. an effective amount of) a compound or a liquid extract as detailed below. Similarly provided therefore is use of said compound or said liquid extract to prevent or inhibit the growth of and/or kill a plant pathogen of the genus Phytophthora on a plant or on a foodstuff derived from a plant. Also provided thereof are means to prevent or treat Phytophthora infection.

The plant or foodstuff can be a plant or foodstuff in need thereof, e.g. a plant or foodstuff with a Phytophthora infection or susceptible to such infection.

The compound of the above mentioned method/use (herein the ‘compound(s) of the disclosure’, or simply ‘compound’, where the context is clear) is described in a later section.

The liquid extract of the above mentioned method/use is a liquid extract from a plant of the genus Artemisia, preferably Artemisia vulgaris, and/or from a leaf and/or stem of said plant and/or wherein the liquid extract comprises water.

The said liquid extract can be a liquid extract obtainable by any of the methods described in the previous section.

An effective amount of the compound or extract can be e.g. an amount that provides a level of growth prevention/inhibition and/or killing of the plant pathogen such that a detectable level of infection prevention or treatment is achieved (e.g. achieving a detectable level of prevention or inhibition of plant tissue damage, or of abrogation of yield loss or food spoilage), preferably in comparison to equivalent conditions where the compound or extract is not present. For example, for a hectare of plants, one might deploy extract obtained from between 1 kg/2 kg and 200 kg of Artemisia plant material, such as 1 kg/2 kg to 150 kg, e.g. 4 kg to 150 kg (e.g. 20 kg to 150 kg), e.g. 4 kg to 100 kg (e.g. 20 kg to 100 kg or 10 kg to 80 kg), most preferably 40-120 kg (e.g. 80 kg) of said plant material. Preferably, the concentration of the extract is between 0.1 kg plant material per litre of extract and 1 kg/L, such as 0.1-0.8 kg/L, e.g. 0.2-0.8 kg/L or 0.2-0.6 kg/L or 0.3-0.5 kg/L (such as 0.4 kg/L).

Alternatively, regards the compounds of the disclosure, these can be applied via an agricultural composition (see below) at a concentration of at least 0.001% by weight, such as at least 0.01%, at least 0.1%, or at least 0.5%, up to e.g. 0.5%, 1%, 2%, 5%, 10%, 20%, 50% or 80% by weight). Each and every combination of these lower and upper limits is also herein contemplated.

Such application of the compound or extract can be repeated such that, over a treatment season, between 1 and 100 applications (e.g. between 1 and 50, between 1 and 30, between 1 and 20, such as between 2 and 50, between 2 and 30, or between 2 and 20) can be made. These applications can be made with e.g. between 1 and 200 days between each application, e.g. between 1 and 100 days, e.g. between 1 and 30 days, e.g. between 2 and 30 days, e.g. between 2 and 15 days.

Preferably, said administering comprises spraying the compound or liquid extract onto said plant or said foodstuff derived from said plant. In the former case, the compound or extract is preferably sprayed onto a flower, fruit, seed, stem and/or, most preferably, a leaf or leaves (foliage) of the plant.

In certain aspects, the compound or extract is administered to a plant in an agricultural setting, particularly e.g. to plants in a field (i.e. exposed to the natural environment, compared with e.g. being housed within a greenhouse). Surprisingly, it has been found that the extract of this disclosure retains pesticidal activity even when applied to plants in field conditions (see below for further details), which is very rare for biologically-derived products.

Preferably, in said methodology, said plant is a crop plant, preferably a food crop plant.

Preferably, the (e.g. food crop) plant/foodstuff is leek (and/or wherein the plant pathogen is P. porri [“white tip disease”]), is from the Cucurbitaceae family, e.g. cucumber, courgette, squash, pumpkin, melon and watermelon (and/or wherein the plant pathogen is P. capsici), is onion (and/or wherein the plant pathogen is P. nicotianae), is strawberry (and/or wherein the plant pathogen is P. fragariae), or is soybean (and/or wherein the plant pathogen is P. sojae)

It is particularly preferred that the (e.g. food crop) plant is a plant of the Solanaceae family (or foodstuff therefrom), and/or wherein the plant pathogen is P. capsici and/or, preferably, P. infestans (i.e. to prevent or treat late blight). Important crop plants/crops within this family include bell peppers, chilli peppers and aubergines, all of which can suffer from Phytophthera infection. In particular, in the provided method, the plant/foodstuff is tomato or, preferably, potato (and/or wherein the plant pathogen is P. infestans). In confidential field trials of late blight infection of potato (see Examples section, below), the extract of the present disclosure provided impressive control of late blight infection, particularly in terms of decreasing foliar blight development and increasing yield, with phytotoxicity being absent. Indeed, the extract performed as well as the strongest fungicide on the market, Infinito®, which has superseded Metalaxyl as the pesticide of choice for this pathogen (and others). This is a significant development as there is currently no biological product on the market with any efficacy for controlling late blight, let alone one with this level of impressive activity.

The foodstuff derived from (e.g. removed or harvested from) a plant can be an appropriate leaf, fruit (including nut), seed (including grain), stem, root, or tuber. Preventing or inhibiting the growth of and/or killing a Phytophthora plant pathogen (also, preventing or treating Phytophthora infection) on such foodstuffs using the disclosed compound or extract therefore provides a means of preventing or inhibiting spoilage of these foodstuffs (i.e. food preservation), where spoilage includes any alteration of a foodstuff by the plant pathogen that results in a change in e.g. the taste, odour or appearance (e.g. shape, colour, texture, firmness) that decreases its nutritional and/or commercial value.

### Detailed Description of the Compounds of the Disclosure

The compounds of the disclosure are defined within the Summary of the Invention. Any pairwise combination of compounds of Formulas I to III is contemplated, particularly of compounds of Formula I and Formula II, as well as a combination of all three.

In relation to Formula I, R¹ can be a substituted or unsubstituted C₂₋₆ alkenyl. For example, R¹ may be a substituted or unsubstituted C₃ alkenyl. In preferred embodiments, R¹ is an unsubstituted C₃ alkenyl, also referred to as a propenyl, or an n-propenyl or an isopropenyl. When R¹ is an n-propenyl, the carbon-carbon double bond may be at the terminus of the alkene, which is to say that R¹ is an allyl, or a 2-propenyl. Alternatively, the carbon-carbon double bond may be in the middle of the alkene, which is to say that R¹ is 1-propenyl.

Alternatively, or in addition, R² is substituted or unsubstituted C₁₋₆ alkyl, such as methyl, ethyl or propyl. In preferred embodiments, R² is methyl.

Optionally, R³ is H. In these embodiments, R² may be C₁₋₆ alkyl (as above) and/or R¹ may be a C₂₋₆ alkenyl (as above). In some preferred embodiments, R³ is H and R² is methyl and/or R¹ is a C₂₋₆ alkenyl (e.g. C₃ alkenyl). In some particularly preferred embodiments, R¹ is propenyl and R² is methyl and R³ is H.

In preferred embodiments, at least one of R² or R³ is other than H.

Preferably, the compound of Formula I is selected from the group consisting of guaiacol, 4-methyl-guaiacol, 4-ethyl-guaiacol, 4-propyl-guaiacol, vanillin, 4-(2-propio)-vanillone, 4-(1-propio)-vanillone, aceto-vanillone, and, particularly, eugenol, Z-isoeugenol, and E-isoeugenol. Most preferably, the compound of Formula I is eugenol:

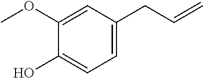

In relation to Formula II, the compound of Formula II can include at least one substituent on the main bridge, that is to say, at least one R¹ on the main bridge is other than H. In preferred embodiments, at least one R¹ on the main bridge is substituted or unsubstituted C₁₋₆ alkyl, for example substituted or unsubstituted methyl, ethyl or propyl. In particularly preferred embodiments, at least one R¹ on the main bridge is methyl.

In some embodiments, the compound of Formula II includes two substituents on the main bridge, that is to say that both R¹ on the main bridge are other than H. In preferred embodiments, both R¹ on the main bridge are substituted or unsubstituted C₁₋₆ alkyl, for example substituted or unsubstituted methyl, ethyl or propyl. In particularly preferred embodiments, both R¹ on the main bridge are methyl.

In some embodiments, the compound of Formula II includes at least one substituent on a bridgehead, that is to say at least one R¹ at a bridgehead is other than H. In preferred embodiments, at least one R¹ at a bridgehead is substituted or unsubstituted C₁₋₆ alkyl, for example substituted or unsubstituted methyl, ethyl or propyl. In particularly preferred embodiments, at least one R¹ at a bridgehead is methyl.

In some embodiments, at least one R¹ at a bridgehead is other than H and the other R¹ at a bridgehead is H. In preferred embodiments, at least one R¹ at a bridgehead is substituted or unsubstituted C₁₋₆ alkyl, for example methyl, ethyl or propyl, and the other R¹ at a bridgehead is H. In particularly preferred embodiments, at least one R¹ at a bridgehead is substituted or unsubstituted C₁₋₆ alkyl and the other R¹ at a bridgehead is H, for example, at least one R¹ at a bridgehead is methyl and the other R¹ at a bridgehead is H.

In some embodiments, the compound of Formula II has at least one substituent on the main ring in a non-bridgehead position, that is to say, at least one non-bridgehead R¹ on the main ring is other than H. In preferred embodiments, at least one non-bridgehead R¹ on the main ring is OR². In particularly preferred embodiments, at least one non-bridgehead R¹ on the main ring is OH.

In some embodiments, the compound of Formula II has two substituents on adjacent carbon atoms of the main ring in non-bridgehead positions, that is to say, at least two adjacent R¹ on the main ring in non-bridgehead positions are other than H. In preferred embodiments, at least two adjacent non-bridgehead R¹ on the main ring are OR². In particularly preferred embodiments, at least two adjacent non-bridgehead R¹ on the main ring are OH.

In some embodiments, both R¹ on the main bridge are substituted or unsubstituted C₁₋₆ alkyl, and/or at least one R¹ at a bridgehead is substituted or unsubstituted C₁₋₆ alkyl and/or the other R¹ at a bridgehead is H and/or at least two adjacent non-bridgehead R¹ on the main ring are OR². In preferred embodiments both R¹ on the main bridge are methyl, and/or at least one R¹ at a bridgehead is methyl, and/or the other R¹ at a bridgehead is H and at least two adjacent non-bridgehead R¹ on the main ring are OH. In particularly preferred embodiments, both R¹ on the main bridge are methyl, and one R¹ at a bridgehead is methyl, and the other R¹ at a bridgehead is H and two adjacent non-bridgehead R¹ on the main ring are OH.

Preferably the compound of Formula II is selected from the group consisting of camphanediol (bornanediol), exo, exo-2,3-camphanediol, exo, endo-2,3 -camphanediol, endo, exo-2,3-camphanediol, endo, endo-2,3-camphanediol, 2,3-trans-camphanediol, 2,3-cis-camphanediol, camphenediol, norbornane (norcamphane), borneol, camphor, camphane (bornane), camphene, norbornane acetic acid, norbornane-carboxylic acid, norbornane-dicarboxylic acid, norbornanediol, 2,3-trans-norbornanediol, 2,3-cis-norbornanediol, 2,7-norbornanediol, norbornanetriol, 2,5,7-norbornanetriol, 2,6,7-norbornanetriol, norborneol, norbornanemethanol, norbornane-2,2-dimethanol, 5-norbene-2,2-dimethanol, 2-(propyl-1,2-diol)-norbornane, 2-hydroxy-2-norbornanemethanol, 1-(2-norbornyl+propane-1,2-diol, and Methyl-5-norbornene-2,3-dimethanol. Preferably the compound of Formula II is exo, exo-2,3-camphanediol:

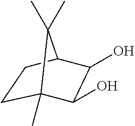

Compounds of Formula II may include groups or substituents as isomers. For the avoidance of any doubt, the present invention includes within its scope, all such isomers, including racemates, enantiomers, diastereomers, tautomers and mixtures thereof.

In relation to Formula III, R¹ can be a substituted or unsubstituted C₁₋₆ alkyl, for example a substituted or unsubstituted methyl, ethyl or propyl. In preferred embodiments, R¹ is methyl.

In some embodiments, R² is H. In particularly preferred embodiments R¹ is methyl and R² is H.

In some embodiments, is a double bond including the carbon substituted by R¹ and OR². In these embodiments, either R¹ or OR² is absent. In preferred embodiments OR² is absent. In particularly preferred embodiments, OR² is absent and R¹ is C₁₋₆ alkyl, for example, methyl.

In some embodiments, R¹ forms a substituted or unsubstituted exocyclic C₂₋₆ alkenyl with the carbon atom of the cyclohexyl ring to which it is attached. In these embodiments, OR² is absent. In preferred embodiment, R¹ forms a substituted or unsubstituted ethenyl (vinyl) with the carbon atom of the cyclohexyl ring to which it is attached and OR² is absent.

In some embodiments, at least one R³ of the compound of Formula III is H. In these embodiments, the other R³ is preferably a substituted or unsubstituted C₁₋₆ alkyl, for example, methyl, ethyl, propyl, or isopropyl. Preferably, the other R³ is a substituted C₁₋₆ alkyl for example, methyl, ethyl, propyl, or isopropyl. Particularly preferably, the other R³ is a substituted isopropyl. The substituted isopropyl maybe substituted with any appropriate substituent. Preferably, the substituted isopropyl is substituted with OH.

In other embodiments, one R³ is H and the other R³ is a substituted or unsubstituted C₂₋₆ alkenyl, for example, a substituted or unsubstituted ethenyl, propenyl, isopropenyl, butenyl or isobutenyl. Preferably, the other R³ is a substituted or unsubstituted isopropenyl. Particularly preferably, the other R³ is an unsubstituted isopropenyl.

In alternative embodiments, the two R³ together form an exocyclic substituted or unsubstituted C₂₋₆ alkenyl with the carbon atom to which they are attached, for example, the two R³ may form a substituted or unsubstituted exocyclic ethenyl, propenyl, butenyl or isobutenyl. Preferably, the two R³ together form an exocyclic substituted or unsubstituted isobutenyl with the carbon atom to which they are attached. Particularly preferably, the two R³ together form an unsubstituted isobutenyl with the carbon atom to which they are attached.

In some embodiments, ----- is a double bond including the carbon substituted by R³ and one R³ is absent. In these embodiments, preferably, the R³ is a substituted or unsubstituted C₁₋₆ alkyl, for example, methyl, ethyl, propyl or isopropyl. Particularly preferably, the other R³ is a substituted or unsubstituted isopropyl. Even more preferably, the other R³ is an unsubstituted isopropyl.

Preferably, the compound of Formula III is terpineol. By terpineol we mean any one or more of the terpineol isomers, as follows:

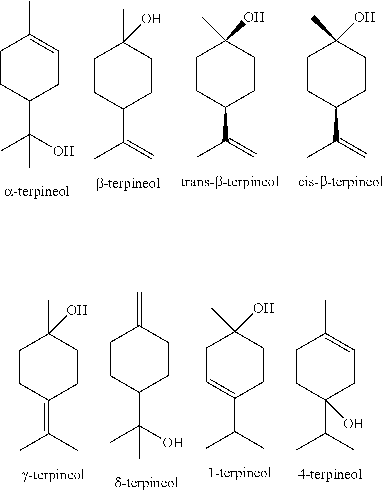

Each of the isomers is singularly contemplated for use in the present invention, particularly α-terpineol. Additionally contemplated is a combination of α-terpineol, γ-terpineol and β-terpineol, and a combination of α-terpineol and γ-terpineol.

Compounds of Formula III may include groups or substituents as isomers. For the avoidance of any doubt, the present invention includes within its scope, all such isomers, including racemates, enantiomers, diastereomers, tautomers and mixtures thereof.

Please note the following definitions:

The term “alkyl” used alone or as part of a larger moiety, such as alkoxy, haloalkyl, arylalkyl, alkylamine, cycloalkyl, dialkyamine, alkylamino, dialkyamino alkylcarbonyl, alkoxycarbonyl and the like, is intended to include branched, straight chain and cyclic, substituted or unsubstituted saturated aliphatic hydrocarbon groups. Alkyl groups can comprise about 1 to about 24 carbon atoms (“C₁₋₂₄”), about 1 to about 10 carbon atoms (“C₁₋₁₀”), about 1 to about 8 carbon atoms (“C₁₋₈”), about 1 to about 6 carbon atoms (“C₁₋₆”), or about 1 to about 3 carbon atoms (“C₁₋₃”). Examples of C₁₋₆ alkyl groups include, but are not limited to, methyl, ethyl, propyl, isopropyl, n-butyl, isobutyl, tert-butyl, n-pentyl, neopentyl, cyclopentyl, cyclohexyl and n-hexyl radicals.

The term “alkenyl” is intended to include branched, straight chain and cyclic, substituted or unsubstituted unsaturated aliphatic hydrocarbon groups containing one or more carbon-carbon double bonds. Alkenyl groups can comprise about 2 to about 24 carbon atoms (“C₂₋₂₄”), about 2 to about 10 carbon atoms (“C₂₋₁₀”), about 2 to about 8 carbon atoms (“C₂₋₈”), about 2 to about 6 carbon atoms (“C₂₋₆”), or about 2 to about 3 carbon atoms (“C₂₋₃”). Examples of C₂₋₆ alkenyl groups include, but are not limited to, ethenyl (vinyl), propenyl (allyl), isopropenyl, butenyl, isobutenyl, pentenyl, isopentenyl, cyclehexenyl, n-hexenyl and isohexenyl radicals.

The term “exocyclic” alkenyl is intended to include branched, straight chain and cyclic, substituted or unsubstituted unsaturated aliphatic hydrocarbon groups containing one or more carbon-carbon double bonds where at least one of the double bonds has one carbon atom as part of a ring. Exocyclic alkenyl groups can comprise about 2 to about 24 carbon atoms (“C₂₋₂₄”), about 2 to about 10 carbon atoms (“C₂₋₁₀”), about 2 to about 8 carbon atoms (“C₂₋₈”), about 2 to about 6 carbon atoms (“C₂₋₆”), or about 2 to about 3 carbon atoms (“C₂₋₃”).

Substituted alkenyl or exocyclic alkenyl groups having two different substituents at each end of a carbon-carbon double bond may exists as stereoisomers (geometric isomers). Where the two substituents are on the same side of the double bond, the alkenyl group may be referred to as a cis-alkenyl. Where the two substituents are on opposite sides of the double bond, the alkenyl group may be referred to as a trans-alkenyl.

The term “alkynyl” is intended to include branched, straight chain and cyclic, substituted or unsubstituted unsaturated aliphatic hydrocarbon groups containing one or more carbon-carbon triple bonds. Alkynyl groups can comprise about 2 to about 24 carbon atoms (“C₂₋₂₄”), about 2 to about 10 carbon atoms (“C₂₋₁₀”), about 2 to about 8 carbon atoms (“C₂₋₈”), about 2 to about 6 carbon atoms (“C₂₋₆”), or about 2 to about 3 carbon atoms (“C₂₋₃”). Examples of C₂₋₆ alkynyl groups include, but are not limited to, ethynyl, propynyl, butynyl, isobutynyl, pentynyl, isopentynyl, cyclehexynyl, n-hexynyl and isohexynyl radicals.

The term “aryl group” used alone or as part of a larger moiety as in “aralkyl”, “aralkoxy”, or “aryloxyalkyl”, includes substituted or unsubstituted carbocyclic aromatic rings and heteroaryl rings and includes ring systems containing one, two or more rings wherein such rings may be attached together in a pendent manner or fused.

The term “aromatic group” may be used interchangeably with the terms “aryl”, “aryl ring” “aromatic ring”, “aryl group” and “aromatic group”. An aromatic group typically has from six to fourteen ring atoms. A “substituted aryl group” is substituted at any one or more substitutable ring atom. Examples of aromatic groups include but are not limited to benzenyl, naphthalenyl, tetrahydronapthalenyl, indenyl, isoindenyl, anthracenyl, and phenanthrenyl.

The term “heteroaryl”, “heteroaromatic”, “heteroaryl ring”, “heteroaryl group” and “heteroaromatic group”, used alone or as part of a larger moiety as in “heteroaralkyl” or “heteroarylalkoxy”, refers to aromatic ring groups having five to fourteen ring atoms selected from carbon and at least one (typically 1-4, more typically 1 or 2) heteroatom (e.g., oxygen, nitrogen or sulphur). They include monocyclic rings and polycyclic rings in which a monocyclic heteroaromatic ring is fused to one or more other carbocyclic aromatic or heteroaromatic rings. Examples of monocyclic heteroaryl groups include furanyl (e.g., 2-furanyl, 3-furanyl), imidazolyl (e.g., N-imidazolyl, 2-imidazolyl, 4-imidazolyl, 5-imidazolyl), isoxazolyl(e.g., 3-isoxazolyl, 4-isoxazolyl, 5-isoxazolyl), oxadiazolyl (e.g., 2-oxadiazolyl, 5-oxadiazolyl), oxazolyl (e.g., 2-oxazolyl, 4-oxazolyl, 5-oxazolyl), pyrazolyl (e.g., 3-pyrazolyl, 4-pyrazolyl), pyrrolyl (e.g., 1-pyrrolyl, 2-pyrrolyl, 3-pyrrolyl), pyridyl (e.g., 2-pyridyl, 3-pyridyl, 4-pyridyl), pyrimidinyl (e.g., 2-pyrimidinyl, 4-pyrimidinyl, 5-pyrimidinyl), pyridazinyl (e.g., 3-pyridazinyl), thiazolyl (e.g., 2-thiazolyl, 4-thiazolyl, 5-thiazolyl), triazolyl (e.g., 2-triazolyl, 5-triazolyl), tetrazolyl (e.g., tetrazolyl) and thienyl (e.g., 2-thienyl, 3-thienyl. Examples of monocyclic six-membered nitrogen-containing heteroaryl groups include pyrimidinyl, pyridinyl and pyridazinyl. Examples of polycyclic aromatic heteroaryl groups include carbazolyl, benzimidazolyl, benzothienyl, benzofuranyl, indolyl, quinolinyl, benzotriazolyl, benzothiazolyl, benzoxazolyl, benzimidazolyl, isoquinolinyl, indolyl, isoindolyl, acridinyl, or benzisoxazolyl.

The term “non-aromatic heterocyclic group”, used alone or as part of a larger moiety as in “non-aromatic heterocyclylalkyl group”, refers to substituted or unsubstituted non-aromatic ring systems typically having five to twelve members, preferably five to seven, in which one or more ring carbons, preferably one or two, are each replaced by a heteroatom such as N, O, or S. A non-aromatic heterocyclic group can be monocyclic or fused bicyclic. A “nitrogen-containing non-aromatic heterocyclic group” is a non-aromatic heterocyclic group with at least one nitrogen ring atom.

Examples of non-aromatic heterocyclic groups include (tetrahydrofuranyl (e.g., 2-tetrahydropyranyl, 3-tetrahydropyranyl, 4-tetrahydropyranyl), [1,3]-dioxalanyl, [1,3]-dithiolanyl, [1,3]-dioxanyl, tetrahydrothienyl (e.g., 2-tetrahydrothienyl, 3-tetrahydrothieneyl), azetidinyl (e.g., N-azetidinyl, 1-azetidinyl, 2-azetidinyl), oxazolidinyl (e.g., N-oxazolidinyl, 2-oxazolidinyl, 4-oxazolidinyl, 5-oxazolidinyl), morpholinyl (e.g., N-morpholinyl, 2-morpholinyl, 3-morpholinyl), thiomorpholinyl (e.g., N-thiomorpholinyl, 2-thiomorpholinyl, 3-thiomorpholinyl), pyrrolidinyl (e.g., N-pyrrolidinyl, 2-pyrrolidinyl, 3-pyrrolidinyl)piperazinyl (e.g., N-piperazinyl, 2-piperazinyl), piperidinyl (e.g., N-piperidinyl), 2-piperidinyl, 3-piperidinyl, 4-piperidinyl), thiazolidinyl (e.g., 4-thiazolidinyl), diazolonyl and N-substituted diazolonyl. The designation “N” on N-morpholinyl, N-thiomorpholinyl, N-pyrrolidinyl, N-piperazinyl, N-piperidinyl and the like indicates that the non-aromatic heterocyclic group is attached to the remainder of the molecule at the ring nitrogen atom.

The term “substituted” shall mean the replacement of one or more hydrogen atoms in a given structure with a substituent. Preferably, 1 to 5 hydrogen atoms in a given structure are replaced with a substituent. More preferably, 1 to 3 hydrogen atoms in a given structure are replaced with a substituent. Suitable substituents include, but are not limited to, halo, alkyl, alkenyl, alkynyl, aryl, heterocyclyl, thiol, alkylthio, arylthio, alkylthioalkyl, arylthioalkyl, alkylsulfonyl, alkylsulfonylalkyl, arylsulfonylalkyl, alkoxy, aryloxy, aralkoxy, aminocarbonyl, alkylaminocarbonyl, arylaminocarbonyl, alkoxycarbonyl, aryloxycarbonyl, haloalkyl, amino, trifluoromethyl, cyano, nitro, alkylamino, arylamino, alkylaminoalkyl, arylaminoalkyl, aminoalkylamino, hydroxy, alkoxyalkyl, carboxyalkyl, alkoxycarbonylalkyl, aminocarbonylalkyl, acyl, aralkoxycarbonyl, carboxylic acid, sulfonic acid, sulfonyl, phosphonic acid, aryl, heteroaryl, heterocyclic, or aliphatic. Preferably, the substituents are halo, alkyl, aryl, alkoxy, aryloxy, amino, nitro, hydroxyl, trifluoromethyl or cyano.

The term “bridged compound” refers to an organic compound that has two or more rings that contain a bridge of one or more atoms connecting one side of the ring to the other. The following nomenclature is used when describing the bridged compounds:

The term “bridgehead” refers to any skeletal atom of the ring system that participates in chemical bonds to 3 or more other non-hydrogen skeletal atoms. Hence, in fully carbocyclic bridged compounds, bridgehead atoms are always tertiary or quaternary carbon atoms.

The term “bridge” can refer either to a single valance bond that connects two bridgehead atoms, or to a chain of atoms between bridgeheads that is unbranched, where the atoms can be carbon atoms or heteroatoms (but not hydrogen).

The term “main ring” refers to a ring that is a part of the ring system, and that is chosen to “include as many skeletal atoms of the polycyclic compound as possible”; i.e., it is most often the ring with the largest number of continuous atoms (carbon or heteroatoms). For instance, in the case of norbornane or camphane, while both cyclohexane and cyclopentane rings are evident within it, the main ring is the cyclohexane ring.

The term “main bridge” refers to a bridge that connects two bridgeheads of the main ring, the main bridge of norbornane or camphane is its only bridge and is the one atom connecting the two bridgehead atoms.

The term “secondary bridge” refers to any other bridges in the ring system that are not the main bridge of the main ring.

The term “racemate” may also be referred to as “racemic mixture”. Racemic mixtures are mixtures of equal quantities of both enantiomers. These mixtures are optically inactive (as they do not present specific rotation) because rotations of opposite sides cancel each other.

The term “enantiomer” or “optical isomer” refers to one of two stereoisomers that are non-superimposable mirror images of each other. Enantiomer are optionally active and present a specific rotation.

The term “diastereomer” refers to non-mirror image non-identical stereoisomers. Diasteromers have different configurations at one or more of the equivalent stereocenters and are not mirror images of each other.

The term “tautomer” refers to constitutional isomers of compounds generated by rapid movement of an atom in two positions in a molecule. Tautomers readily interconvert into each other, e.g. enol form and ketone form are typical tautomers.

The term “agriculturally acceptable salt” can mean e.g. a salt of a free acid or base of a compound of Formula I, II or III that exhibits corresponding activity to the compound of Formula I, II or III, or that are or can be converted in plants, water or soil to compound I, II or III. Exemplary agriculturally acceptable salts include those derived from alkali (e.g. sodium and potassium salts) or alkaline earth metals (e.g. calcium and magnesium salts) and those derived from ammonia and amines. Exemplary cations include sodium, potassium, magnesium and aminium cations of the formula R¹R²R³R⁴N⁺ where R¹, R², R³, and R⁴ each independently represents H, alkyl, alkenyl, or alkynyl groups.

The term “solvate” means solvent addition forms that contain either stoichiometric or non-stoichiometric amounts of solvent. For example, if the solvent is water, the solvate formed is a hydrate and if the solvent is an alcohol, the solvate formed is an alcoholate.

### Agricultural Compositions

Compositions, particularly agricultural compositions, comprising one or more of the compounds of the disclosure are provided, per se and for deployment in the above detailed method/use. These compositions can be formulations, that is, compositions formulated by combining a compound(s) of the disclosure with other agriculturally acceptable (e.g. non-phytotoxic) chemical entities, such as an agriculturally acceptable carrier and/or diluent (within which e.g. the compound(s) is solubilised), preferably a liquid carrier and/or diluent. Depending on the compound in hand, the carrier/diluent could be polar (e.g. aqueous, such as water) or non-polar. Organic solvents are particularly contemplated. In preferred embodiments, such a formulation is free or substantially free of saccharides (e.g.

one or more saccharides make up less than 5% by weight of the formulation, such as less than 3% by weight, e.g. less than 1% by weight or less than 0.5% by weight or less that 0.1% by weight or less than 0.01% by weight or less than 0.001% by weight).

Particularly provided is a compound and an agricultural spray adjuvant (as detailed above), wherein said compound is selected as described previous sections.

### General

Please note that wherever the term ‘comprising’ is used herein we also contemplate options wherein the terms ‘consisting of’ or ‘consisting essentially of’ are used instead.

### EXAMPLES

### Example 1

Whole stem and leaf sections of Artemisia vulgaris were harvested and shredded using a garden shredder. Shredded material (2 kg or 4 kg) was added to a container, into which was added 10L of boiling water. Decoction lasted 24 hr, at which point the water was sieved. Remaining plant material was pressed to release residual fluid into the water extract. This extract was optionally also filtered on a batch by batch basis. The resultant extract was designated AV2000 or AV4000 (for, respectively, 2 kg or 4 kg input of plant material).

### Example 2

AV4000 was subject to a field trial in relation to P. infestans infection of potato plants, as described below:

### Objectives

To compare the efficacy and crop safety of a range of fungicide programmes for the control of late blight (P. infestans) in potatoes.

### Materials and Methods

Trial number: RAA 15-2017

Co-operator: F Daubney & Sons

Site:
Bayholme Farm
Wainfleet Road
Old Leake
Boston
Lincolnshire

Grid reference: TF 413504

Soil type: silt loam

Previous crop (2016): Brassicas

Crop & Cultivar: Maincrop potatoes—Melody

Planting Date: 01.06.2017

Plot Maintenance

Treatments: Weed and aphid control consistent with good local practice.

Plot size: 6.5 m×2 m

Design: RCB X4 replication

Treatment list

| | |
|---|---|
| 1 - Untreated corridor | — |
| 2 - Infinito ® (1.6 L in 200 L/ha) | T1-T12 |
| 3 - AV4000 (200 L/ha) | T1-T12 |

Spray interval of 7-10 days depending on disease pressure.

Untreated refers to untreated corridors—not an experimental plot within the layout; the actives in Infinito® are propamocarb and fluopicolide (ai of 625 and 62.5 g/L).

### Application Details

Applicator: Pulvexpur plot sprayer - CO₂ pressurised (RAA01)
Nozzles: FF015 110 Lo Drift
Pressure: 3 bar
Speed: 1.0 m/s
Water Volume: 200 L/ha

| | T1 | T2 |
|---|---|---|
| Date: | 3 Jul. 2017 | 10 Jul. 2017 |
| Crop Stage: | 15 | 21 |
| Leaf Moisture: | Dry | Dry |
| Soil Moisture (Surface): | Dry | Dry |
| Soil Moisture (Sub-surface): | Moist | Moist |
| Soil Condition: | Loose | Loose |
| Soil Tilth: | Small clods | Small clods |
| Weather at application: | Sunny | Overcast |
| Air temperature (Deg. C.): | 22 | 20 |
| Soil temperature (Deg. C.): | 24 | 21 |
| Wind (kph): | 2 | 2 |
| Wind (direction): | NE | E |
| Cloud cover (%): | 60 | 75 |
| Comment: | Conducive weather | Conducive weather |

| | T3 | T4 |
|---|---|---|
| Date: | 17 Jul. 2017 | 25 Jul. 2017 |
| Crop Stage: | 25 | 28 |
| Leaf Moisture: | Dry | Dry |
| Soil Moisture (Surface): | Dry | Damp |
| Soil Moisture (Sub-surface): | Wet | Moist |
| Soil Condition: | Loose | Loose |
| Soil Tilth: | Small clods | Small clods |
| Weather at application: | Sunny | Overcast |
| Air temperature (Deg. C.): | 21 | 21 |
| Soil temperature (Deg. C.): | 21 | 19 |
| Wind (kph): | 0 | 2 |
| Wind (direction): | — | E |
| Cloud cover (%): | 60 | 70 |
| Comment: | Conducive weather | No disease |

| | T5 | T6 |
|---|---|---|
| Date: | 2 Aug. 2017 | 7 Aug. 2017 |
| Crop Stage: | 31 | 32 |
| Leaf Moisture: | Dry | Dry |
| Soil Moisture (Surface): | Damp | Dry |
| Soil Moisture (Sub-surface): | Moist | Damp |
| Soil Condition: | Loose | Loose |
| Soil Tilth: | Small clods | Small clods |
| Weather at application: | Overcast | Overcast |
| Air temperature (Deg. C.): | 21 | 20 |
| Soil temperature (Deg. C.): | 19 | 20 |
| Wind (kph): | 1 | 2 |
| Wind (direction): | NE | E |
| Cloud cover (%): | 80 | 85 |
| Comment: | Trace disease | — |

| | T7 | T8 |
|---|---|---|
| Date: | 14 Aug. 2017 | 22 Aug. 2017 |
| Crop Stage: | 38 | 39 |
| Leaf Moisture: | Dry | Dry |
| Soil Moisture (Surface): | Dry | Dry |
| Soil Moisture (Sub-surface): | Damp | Damp |
| Soil Condition: | Loose | Loose |
| Soil Tilth: | Small clods | Small clods |
| Weather at application: | Sunny | Sunny |
| Air temperature (Deg. C.): | 21 | 22 |
| Soil temperature (Deg. C.): | 20 | 22 |
| Wind (kph): | 2 | 0 |
| Wind (direction): | NE | — |
| Cloud cover (%): | 45 | 30 |
| Comment: | — | — |

| | T9 | T10 |
|---|---|---|
| Date: | 29 Aug. 2017 | 6 Sep. 2017 |
| Crop Stage: | 61 | |
| Leaf Moisture: | Dry | Dry |
| Soil Moisture (Surface): | Dry | Moist |
| Soil Moisture (Sub-surface): | Damp | Moist |
| Soil Condition: | Loose | Loose |
| Soil Tilth: | Small clods | Small clods |
| Weather at application: | Overcast | Overcast |
| Air temperature (Deg. C.): | 20 | 20 |
| Soil temperature (Deg. C.): | 19 | 19 |
| Wind (kph): | 0 | 1 |
| Wind (direction): | — | NE |
| Cloud cover (%): | 95 | 80 |
| Comment: | — | — |

| | T11 | T12 |
|---|---|---|
| Date: | 20 Sep. 2017 | 4 Oct. 2017 |
| Crop Stage: | | |
| Leaf Moisture: | Dry | Dry |
| Soil Moisture (Surface): | Dry | Dry |
| Soil Moisture (Sub-surface): | Damp | Damp |
| Soil Condition: | Loose | Loose |
| Soil Tilth: | Small clods | Small clods |
| Weather at application: | Sunny | Sunny |
| Air temperature (Deg. C.): | 16 | 16 |
| Soil temperature (Deg. C.): | 16 | 15 |
| Wind (kph): | 2 | 1 |
| Wind (direction): | S | E |
| Cloud cover (%): | 35 | 50 |
| Comment: | | |

All plots desiccated 12 Oct. 2017 (Reglone - 4.0 L)
No irrigation was applied during the growing season.

### Assessment Methods

The following assessments were carried out on the trial:

### At Application

Soil and climatic data were recorded at each application timing.

A visual assessment of the percentage haulm area infected by P. infestans was made in the untreated strips.

### Crop Phytotoxicity

Visual assessments of the percentage crop chlorosis, necrosis, growth reduction and stand reduction were made at each application during the trial period.

### Foliar Blight

Foliage blight (foliage blight comprises stem blight plus leaf blight) was assessed as percentage of haulm affected by blight lesions.

### Tuber Blight and Tuber Number at Harvest

The central 2 m length of row was lifted from each plot. The number of lifted tubers affected by blight and the number unaffected by blight were counted in each plot. This allowed calculation of total tuber numbers per 3 m row length and the percentage tubers affected by blight.

### Tuber Blight (Post Storage)

A random sample of 50 tubers per plot, was stored at ambient temperature for 10 weeks. Tubers were then sliced open to identify the causes of any rot. The occurrence of granular, rusty-brown symptoms, developing around the vascular tissues, was used to positively identify tuber blight.

### Crop Yield

Crop yield was determined by hand-lifting the central 4 m of each plot. Potatoes were graded into <45 mm (undersize) and >45 mm (ware) size fractions.

### Protocol Details

(a) Assessments

Trial conducted in accordance with EPPO (European and Mediterranean Plant Protection Organisation) guidelines.

PP 1/135 (3): Phytotoxicity

PP 1/152 (4): Design and analysis of efficacy evaluation trials.

PP 1/181 (4): Conduct and reporting of efficacy trials including GLP

PP 1/2 (4): P. infestans on potato.

Assess crop safety at each application.

Blight infection levels as required, depending on speed of epidemic development.

Yield and grade—<45 mm and >45 mm (t/ha)

Tuber blight at lifting and after 8-10 weeks of ambient storage.

(b) Special Instructions

Inoculation of infection corridors with “Blue 13”/“Pink 6” strains of late blight—delivery by spore suspension and laboratory-infected plants.

Mist irrigation as required to promote spore germination and sporulation.

Appropriate transformations and analysis were carried out on the data.

Application of maintenance sprays as necessary.

### Results and Discussion

### Crop Phytotoxicity

Crop phytotoxicity was assessed at each application. No crop effects were seen for any treatment at any application timing.

### Potato Late Blight (P. Infestans) Development in 2017

Weather conditions during the 2017 growing season were occasionally very conducive to blight development, although there were other periods of weather, not conducive to disease development.

Mist irrigation was routinely employed during the season to increase blight sporulation and overall disease pressure.

The complete trial area was desiccated 12.10.2017 when it became evident that further foliar disease assessments would not differentiate fungicide programmes.

P. infestans in untreated corridors developed from 0% (of foliage infected) at 17 Jul. 3017 to 100% by 20 Sep. 2017.

### The Effect of Fungicide Treatment on Foliar Blight Development

Late-season blight pressure was ideal for providing a good test of the comparative efficacy of fungicides. Significant (P=0.05) differences between fungicides were obtained.

All fungicide treatments reduced blight levels compared to the untreated control.

Note, for all tables below—

Pest type: D Disease

Pest code: PHYTIN

Pest scientific name: Phytophthora i>

Pest name: Late blight of>

Crop code: SOLTU

BBCH Scale: BPOT

Crop scientific name: Solanum tubero>

Crop name/variety: Potato/Melody

Part Rated: PLOT—

TABLE 1
Effect of fungicide on foliar blight levels - % of haulm infected - Assessed
Aug. 2, 2017, Aug. 7, 2017, Aug. 14, 2017, Aug. 22, 2017, Aug. 29, 2017.

| Rating date | 2 Aug. 2017 | 7 Jul. 2017 | 14 Aug. 2017 | 22 Aug. 2017 | 29 Aug. 2017 |
|---|---|---|---|---|---|
| Rating type | DAMDIS | DAMDIS | DAMDIS | DAMDIS | DAMDIS |
| Rating unit | % | % | % | % | % |
| No. of subsamples | 1 | 1 | 1 | 1 | 1 |
| Days after first/ | 30/8 | 35/5 | 42/7 | 50/8 | 57/7 |
| last application | | | | | |
| Treatment no. | 5 | 6 | 7 | 8 | 9 |
| 1 Un. corridor | 7.0a | 15.0a | 35.00a | 60.0a | 75.0a |
| 2 Infinito ® | 0.0b | 0.0b | 0.53b | 4.5b | 5.3c |
| 3 AV 4000 | 0.0b | 0.0b | 0.70b | 5.8b | 7.5b |
| LSD P = .05 | 0.00 | 0.00 | 0.350 | 1.66 | 2.18 |
| Std. deviation | 0.00 | 0.00 | 0.202 | 0.96 | 1.26 |
| CV | 0.0 | 0.0 | 1.67 | 4.09 | 4.3 |
| Replicate F | 0.000 | 0.000 | 0.347 | 0.818 | 2.579 |
| Replicate Prob(F) | 1.0000 | 1.0000 | 0.7931 | 0.5293 | 0.1492 |
| Treatment F | 0.000 | 0.000 | 38613.004 | 4381.728 | 3969.000 |
| Treatment Prob(F) | 1.0000 | 1.0000 | 0.0001 | 0.0001 | 0.0001 |

Means followed by same letter do not significantly differ (P = .05, LSD)

Untreated control data is from “untreated corridors” and is therefore not included in the overall statistical analysis of data.

TABLE 2
Effect of fungicide on foliar blight levels - % of haulm infected -
Assessed Sep. 6, 2017, Sep. 20, 2017, Oct. 4, 2017, Oct. 18, 2017

| Rating date | 6 Sep. 2017 | 20 Sep. 2017 | 4 Oct. 2017 | 18 Oct. 2017 |
|---|---|---|---|---|
| Rating type | DAMDIS | DAMDIS | DAMDIS | DAMDIS |
| Rating unit | % | % | % | % |
| No. of subsamples | 1 | 1 | 1 | 1 |
| Days after first/ | 65/8 | 79/14 | 93/14 | 107/14 |
| last application | | | | |
| Treatment no. | 10 | 11 | 12 | 13 |
| 1 Un. corridor | 85.0a | 100.0a | 100.0a | 100.0a |
| 2 Infinito ® | 5.8b | 7.5b | 12.3b | 18.5c |
| 3 AV 4000 | 7.8b | 10.0b | 14.3b | 21.5b |
| LSD P = .05 | 2.06 | 3.60 | 2.69 | 2.83 |
| Std. deviation | 1.19 | 2.08 | 1.55 | 1.63 |
| CV | 3.63 | 5.31 | 3.69 | 3.5 |
| Replicate F | 2.588 | 0.077 | 2.069 | 2.750 |
| Replicate Prob(F) | 0.1484 | 0.9702 | 0.2058 | 0.1348 |
| Treatment F | 5765.706 | 2563.462 | 4153.690 | 3203.375 |
| Treatment Prob(F) | 0.0001 | 0.0001 | 0.0001 | 0.0001 |

Means followed by same letter do not significantly differ (P = .05, LSD).

### Potato Blight (P. Infestans) Development (Tuber Symptoms)

Even in a season of early and high blight pressure, tuber blight symptoms are often absent in Melody. Tuber blight levels at lifting, were zero for both untreated and treated plots. The late occurrence of disease pressure, especially in the treated plots, did not allow sufficient time for tuber blight symptoms to have developed at lifting.

Zero levels of tuber blight were also found after 10 weeks ambient storage, indicating that tubers had not been infected by blight, late in the growing season, before the manifestation of symptoms at lifting.

TABLE 3
Effect of fungicide on levels of tuber blight
infection - % of tubers blighted.

| Rating date | 18 Dec. 2017 | 18 Dec. 2017 |
|---|---|---|
| Rating type | INFEST | INFEST |
| Rating unit | % | % |
| No. of subsamples | 1 | 1 |
| Days after first/ | 168/75 | 168/75 |
| last application | | |
| Treatment no. | 15 | 16 |
| 1 Un. corridor | 0.0a | 0.0a |
| 2 Infinito ® | 0.0a | 0.0a |
| 3 AV 4000 | 0.0a | 0.0a |
| LSD P = .05 | 0.00 | 0.00 |
| Std. deviation | 0.00 | 0.00 |
| CV | 0.0 | 0.0 |
| Replicate F | 0.000 | 0.000 |
| Replicate Prob(F) | 1.0000 | 1.0000 |
| Treatment F | 0.000 | 0.000 |
| Treatment Prob(F) | 1.0000 | 1.0000 |

Means followed by same letter do not significantly differ (P = .05, LSD)

Untreated control data is from “untreated corridors” and is therefore not included in the overall statistical analysis of data.

### Yield and Tuber Size Distribution

Uncontrolled blight in the untreated corridors reduced yield, compared to the fungicide treated plots. Since a large proportion of the yield was already

TABLE 4
Effect of fungicide on potato yield/grade

| Rating date | 18 Dec. 2017 | 18 Dec. 2017 |
|---|---|---|
| Rating type | INFEST | INFEST |
| Rating unit | kg | kg |
| Tuber size | <45 mm | >45 mm |
| Days after first/ | 168/75 | 168/75 |
| last application | | |
| Treatment no. | 15 | 16 |
| 1 Un. corridor | 2.050a | 7.415b |
| 2 Infinito ® | 0.495b | 13.055a |
| 3 AV 4000 | 0.360b | 12.655a |
| LSD P = .05 | 0.4798 | 2.6885 |
| Std. deviation | 0.2773 | 1.5538 |
| CV | 28.64 | 14.07 |
| Replicate F | 1.164 | 0.206 |
| Replicate Prob(F) | 0.3980 | 0.8887 |
| Treatment F | 45.887 | 16.410 |
| Treatment Prob(F) | 0.0002 | 0.0037 |

Means followed by same letter do not significantly differ (P = .05, LSD)

Untreated control data is from “untreated corridors” and is therefore not included in the overall statistical analysis of data.

### Example 3

Extract was subject to a further field trial, again in relation to P. infestans infection of potato plants. Details were the same as for Example 2, above, except that the previous crop was potato (from the Example 2 trial) and that extract was applied at different concentrations: in addition to AV4000 (200 L/ha), herein “Rate 2”, AV2000 and AV6000 were used, herein “Rate 1” and “Rate 3” respectively. These, too, were applied at 200 L/ha. AV2000 was made using 2 kg plant material in 10 L, whilst AV6000 was made using 6 kg plant material in 10 L water.

### Application Details

Applicator: Pulvexpur plot sprayer - CO₂ pressurised (RAA01)
Nozzles: FF015 110 Lo Drift
Pressure: 3 bar; Speed: 1.0 m/s; Water Volume: 200 L/ha

| | T1 | T2 |
|---|---|---|
| Date: | 24 Jul. 2018 | 31 Jul. 2018 |
| Crop Stage: | BBCH 12 | BBCH 17 |
| Leaf Moisture: | Dry | Dry |
| Soil Moisture (Surface): | Dry | Dry |
| Soil Moisture (Sub-surface): | Dry | Dry |
| Soil Condition: | Loose | Loose |
| Soil Tilth: | Small clods | Small clods |
| Weather at application: | Sunny | Sunny |
| Air temperature (Deg. C.): | 16 | 18 |
| Soil temperature (Deg. C.): | 16 | 15 |
| Wind (kph): | 2 | 3 |
| Wind (direction): | NE | S |
| Cloud cover (%): | 20 | 25 |
| Comment: | Unconducive weather | Unconducive weather |
| | conditions | conditions |

| | T3 | T4 |
|---|---|---|
| Date: | 7 Aug. 2018 | 14 Aug. 2018 |
| Crop Stage: | BBCH 31 | BBCH 32 |
| Leaf Moisture: | Dry | Dry |
| Soil Moisture (Surface): | Dry | Damp |
| Soil Moisture (Sub-surface): | Dry | Dry |
| Soil Condition: | Loose | Loose |
| Soil Tilth: | Small clods | Small clods |
| Weather at application: | Sunny | Sunny |
| Air temperature (Deg. C.): | 15 | 16 |
| Soil temperature (Deg. C.): | 12 | 13 |
| Wind (kph): | 1 | 2 |
| Wind (direction): | E | NE |
| Cloud cover (%): | 10 | 0 |
| Comment: | Unconducive weather | No disease |

| | T5 | T6 |
|---|---|---|
| Date: | 21 Aug. 2018 | 28 Aug. 2018 |
| Crop Stage: | BBCH 34 | BBCH 35 |
| Leaf Moisture: | Dry | Dry |
| Soil Moisture (Surface): | Dry | Dry |
| Soil Moisture (Sub-surface): | Dry | Dry |
| Soil Condition: | Loose | Loose |
| Soil Tilth: | Small clods | Small clods |
| Weather at application: | Sunny | Overcast |
| Air temperature (Deg. C.): | 22 | 14 |
| Soil temperature (Deg. C.): | 16 | 14 |
| Wind (kph): | 3 | 1 |
| Wind (direction): | NE | E |
| Cloud cover (%): | 10 | 60 |
| Comment: | Trace disease | Trace disease |

| | T7 | T8 |
|---|---|---|
| Date: | 4 Sep. 2018 | 11 Sep. 2018 |
| Crop Stage: | BBCH 37 | BBCH 39 |
| Leaf Moisture: | Dry | Dry |
| Soil Moisture (Surface): | Dry | Dry |
| Soil Moisture (Sub-surface): | Dry | Dry |
| Soil Condition: | Loose | Loose |
| Soil Tilth: | Small clods | Small clods |
| Weather at application: | Overcast | Sunny |
| Air temperature (Deg. C.): | 12 | 12 |
| Soil temperature (Deg. C.): | 10 | 18 |
| Wind (kph): | 1 | 2 |
| Wind (direction): | S | NE |
| Cloud cover (%): | 75 | 85 |

| | T9 | T10 |
|---|---|---|
| Date: | 18 Sep. 2018 | 25 Sep. 2018 |
| Crop Stage: | BBCH 65 | BBCH 68 |
| Leaf Moisture: | Dry | Dry |
| Soil Moisture (Surface): | Dry | Dry |
| Soil Moisture (Sub-surface): | Dry | Dry |
| Soil Condition: | Loose | Loose |
| Soil Tilth: | Small clods | Small clods |
| Weather at application: | Overcast | Sunny |
| Air temperature (Deg. C.): | 11 | 10 |
| Soil temperature (Deg. C.): | 10 | 8 |
| Wind (kph): | 2 | 1 |
| Wind (direction): | N | E |
| Cloud cover (%): | 50 | 20 |

| | T11 | T12 |
|---|---|---|
| Date: | 2 Oct. 2018 | 9 Oct. 2018 |
| Crop Stage: | BBCH 81 | BBCH 91 |
| Leaf Moisture: | Dry | Dry |
| Soil Moisture (Surface): | Dry | Dry |
| Soil Moisture (Sub-surface): | Dry | Dry |
| Soil Condition: | Loose | Loose |
| Soil Tilth: | Small clods | Small clods |
| Weather at application: | Sunny | Sunny |
| Air temperature (Deg. C.): | 9 | 10 |
| Soil temperature (Deg. C.): | 8 | 9 |
| Wind (kph): | 1 | 2 |
| Wind (direction): | NE | SE |
| Cloud cover (%): | 0 | 15 |

All plots desiccated (Reglone - 4.0 l)

### Results and Discussion

### Crop Phytotoxicity

Crop phytotoxicity was assessed at each application. No crop effects were seen for any treatment at any application timing.

### Potato Late Blight (P. Infestans) Development in 2018

Weather conditions during the 2018 growing season were not favourable for late blight. The disease is more likely to occur during a ‘Smith period’, which is when the minimum temperature is 10° C. or above for two days, with a relative humidity of more than 90 per cent for at least 11 hours each day.

June-August: Periods of warm, dry, sunny weather prevented infection from developing and spreading in the untreated corridors.

Despite the introduction of infected potato plants in the untreated plots, late blight was slow to develop, even when conditions became more ideal from mid-august onwards.

Mist irrigation was routinely employed during the season to increase blight sporulation and overall disease pressure.

P. infestans in untreated corridors developed from 0% (of foliage infected) at 24 Jul. 2018 to approx. 85% by 9 Oct. 2018.

### The Effect of Fungicide Treatment on Foliar Blight Development

See Tables 5 to 7 below. Means followed by same letter do not significantly differ (P=0.05, LSD). All fungicide treatments were significantly (P=0.05) effective at controlling late blight compared to the untreated corridor. There was a significant (P=0.05) difference in control between the Experimental treatments. Rate 2 (Rate 4.0 kg) was significantly (P=0.05) the best performing treatment, compared with Rate 3 (Rate 6.0 kg) and further with Rate 1 (Rate 2.0 kg).

Note, for all tables below—

Pest ID Code: D Disease

Pest code: PHYTIN

Pest scientific name: Phytophthora i>

Pest name: Late blight of>

Crop ID code: SOLTU

BBCH Scale: BPOT

Crop scientific name: Solanum tubero>

Crop name: Potato

Part Rated: LEAF—

TABLE 5
Effect of fungicide on foliar blight levels - % of haulm infected - Assessed
Jul. 24, 2018, Jul. 31, 2018, Aug. 7, 2018, Aug. 14, 2018 and Aug. 21, 2018

| Rating date | 24 Jul. 2018 | 31 Jul. 2018 | 7 Aug. 2018 | 14 Aug. 2018 | 21 Aug. 2018 |
|---|---|---|---|---|---|
| Rating type | PESSEV | PESSEV | PESSEV | PESSEV | PESSEV |
| Rating unit | % | % | % | % | % |
| No. of subsamples | 1 | 1 | 1 | 1 | 1 |
| Trt-Eval interval | 0 DA-A | 7 DA-A | 14 DA-A | 21 DA-A | 28 DA-A |
| No. of decimals | 1 | 1 | 1 | 1 | 1 |
| Treatment no. | 1 | 2 | 3 | 4 | 5 |
| 1 Un. corridor | 0.0a | 0.0a | 0.0a | 0.0a | 5.8a |
| 2 Exptl. (Rate 1) | 0.0a | 0.0a | 0.0a | 0.0a | 0.0b |
| 3 Exptl. (Rate 2) | 0.0a | 0.0a | 0.0a | 0.0a | 0.0b |
| 4 Exptl. (Rate 3) | 0.0a | 0.0a | 0.0a | 0.0a | 0.0b |
| 5 Infinito ® | 0.0a | 0.0a | 0.0a | 0.0a | 0.0b |
| LSD P = .05 | | | | | 1.03 |
| Std. deviation | 0.00 | 0.00 | 0.00 | 0.00 | 0.67 |
| CV | 0.0 | 0.0 | 0.0 | 0.0 | 58.33 |
| Replicate F | 0.000 | 0.000 | 0.000 | 0.000 | 1.000 |
| Replicate Prob(F) | 1.0000 | 1.0000 | 1.0000 | 1.0000 | 0.4262 |
| Treatment F | 0.000 | 0.000 | 0.000 | 0.000 | 58.778 |
| Treatment Prob(F) | 1.0000 | 1.0000 | 1.0000 | 1.0000 | 0.0001 |

TABLE 6
Effect of fungicide on foliar blight levels - % of haulm infected - Assessed
Aug. 28, 2018, Sep. 4, 2018, Sep. 11, 2018, Sep. 18, 2018 and Sep. 25, 2018

| Rating date | 28 Aug. 2018 | 4 Sep. 2018 | 11 Sep. 2018 | 18 Sep. 2018 | 25 Sep. 2018 |
|---|---|---|---|---|---|
| Rating type | PESSEV | PESSEV | PESSEV | PESSEV | PESSEV |
| Rating unit | % | % | % | % | % |
| No. of subsamples | 1 | 1 | 1 | 1 | 1 |
| Trt-Eval interval | 35 DA-A | 42 DA-A | 49 DA-A | 56 DA-A | 63 DA-A |
| No. of decimals | 1 | 1 | 1 | 1 | 1 |
| Treatment no. | 6 | 7 | 8 | 9 | 10 |
| 1 Un. corridor | 14.5a | 23.0a | 38.3a | 55.0a | 62.5a |
| 2 Exptl. (Rate 1) | 0.0b | 0.0b | 1.4b | 2.8b | 4.8b |
| 3 Exptl. (Rate 2) | 0.0b | 0.0b | 0.4b | 1.5b | 2.5c |
| 4 Exptl. (Rate 3) | 0.0b | 0.0b | 1.1b | 2.3b | 3.8bc |
| 5 Infinito ® | 0.0b | 0.0b | 0.5b | 1.4b | 2.0c |
| LSD P = .05 | 2.29 | 1.69 | 4.23 | 3.08 | 1.07 |
| Std. deviation | 1.48 | 1.10 | 2.75 | 2.00 | 1.28 |
| CV | 51.15 | 23.81 | 33.0 | 15.88 | 8.49 |
| Replicate F | 1.000 | 1.000 | 1.247 | 0.572 | 2.802 |
| Replicate Prob(F) | 0.4262 | 0.4262 | 0.3360 | 0.6444 | 0.0852 |
| Treatment F | 76.455 | 352.667 | 148.396 | 564.542 | 1713.548 |
| Treatment Prob(F) | 0.0001 | 0.0001 | 0.0001 | 0.0001 | 0.0001 |

TABLE 7
Effect of fungicide on foliar blight levels - % of haulm
infected - Assessed Oct. 2, 2018 and Oct. 9, 2018.

| Rating date | 2 Oct. 2018 | 9 Oct. 2018 |
|---|---|---|
| Rating type | PESSEV | PESSEV |
| Rating unit | % | % |
| No. of subsamples | 1 | 1 |
| Trt-Eval interval | 70 DA-A | 77 DA-A |
| No. of decimals | 1 | 1 |
| Treatment no. | 11 | 12 |
| 1 Un. corridor | 67.5a | 85.0a |
| 2 Exptl. (Rate 1) | 6.8b | 11.5b |
| 3 Exptl. (Rate 2) | 5.5b | 8.1d |
| 4 Exptl. (Rate 3) | 7.3b | 9.8c |
| 5 Infinito ® | 5.8b | 8.3cd |
| LSD P = .05 | 2.27 | 1.54 |
| Std. deviation | 1.47 | 1.00 |
| CV | 7.95 | 4.07 |
| Replicate F | 1.556 | 1.586 |
| Replicate Prob(F) | 0.2512 | 0.2443 |
| Treatment F | 1378.012 | 4598.172 |
| Treatment Prob(F) | 0.0001 | 0.0001 |

### Potato Blight (P. Infestans) Development (Tuber Symptoms)

Tuber blight levels at lifting were zero for both untreated and treated plots. The late occurrence of disease pressure, especially in the treated plots, did not allow sufficient time for tuber blight symptoms to develop. In addition, no symptoms of tuber blight were found after 10 weeks ambient storage, indicating that tubers had not been infected by blight late in the growing season.

### Yield and Tuber Size Distribution

Uncontrolled blight in the untreated corridors significantly (P=0.05) reduced yield compared to the fungicide treated plots.

TABLE 8
Effect of fungicide on potato yield/grade - t/ha

| Rating date | 18 Dec. 2018 | 18 Dec. 2018 |
|---|---|---|
| Rating type | YIELD | YIELD |
| Rating unit | t/ha | t/ha |
| Description | <45 mm | >45 mm |
| No. of subsamples | 1 | 1 |
| Treatment no. | 19 | 20 |
| 1 Un. corridor | 10.102131a | 51.235165c |
| 2 Exptl. (Rate 1) | 5.126251b | 63.264766ab |
| 3 Exptl. (Rate 2) | 5.864431b | 63.155406ab |
| 4 Exptl. (Rate 3) | 9.486981a | 58.575956c |
| 5 Infinito ® | 4.169350b | 68.664417a |
| LSD P = .05 | 3.3999269 | 8.7574401 |
| Std. deviation | 2.2068085 | 5.6842380 |
| CV | 31.75 | 9.32 |
| Replicate F | 0.886 | 0.491 |
| Replicate Prob(F) | 0.4761 | 0.6953 |
| Treatment F | 5.874 | 5.254 |
| Treatment Prob(F) | 0.0074 | 0.0111 |

Means followed by same letter do not significantly differ (P = .05, LSD).

### Example 4

AV4000 (10 g) was evaporated at 50° C. and 2 mbar to dryness to yield brownish solid (284 mg). Solid content of extract was determined to be 2.84% w/w. This solid material was dissolved in deuterated water for ¹H and ¹³C Nuclear Magnetic Resonance (NMR) analyses.

¹H NMR spectrum showed that the majority of the solid extract was a mixture of sugars. Minor components are phenolic compounds with peak shifts from 6.4 to 8.4 ppm. The characteristic proton peaks with shifts in region of 3.1 to 5 ppm can be attributed to sugars like fructose, glucose and sucrose. ¹³C NMR spectrum confirmed that the majority of the solid extract was a mixture of sugars, such as fructose, glucose and sucrose (with characteristic carbon shifts in region of 60 to 105 ppm).

Heavy metal analysis of AV4000 was undertaken via ICP-OS. The extract was dried to the solid content and then taken up in solvent to ensure full compositional analysis. A semi-quantitative analysis of the residue was undertaken to give a full spectrum analysis of the sample. The extract showed no unusual or harmful heavy metals in solution. The metals and the levels at which they were found indicated that trace metals had been picked up from the soil during plant growth. Iron, zinc and sulphur were detected at significant levels.

Finally, analysis of volatile components of the extract was performed by GCMS. As the extract is a water based solution, it cannot be analysed by GCMS directly and therefore had to be prepared in a solvent solution. Volatile components were extracted from extract to ethyl acetate and this solution was analysed by GCMS. The major volatile components were identified as Terpineol (Rt=13.30 min), Eugenol (Rt=17.42 min) and 2,3-Bornanediol (Rt=18.00 min). The analysis also suggested that other volatiles may be present in the extract; however, these were at such low concentrations that they could not be identified.

In summary, the extract contained:
water (approx. 95%)
mono- and disaccharides (fructose, glucose and sucrose)
iron, zinc and sulphur
volatiles, of which terpineol, eugenol and 2,3-Bornanediol were in quantities enabling their detection.

### Example 5

The effect of each of the three identified volatiles (Terpineol, Eugenol and 2,3-Bornanediol) against the growth of Pythopthora infestans was assessed. Genotype 13_A2 was used and cultured specifically for the trial, having been isolated from potatoes.

CMA (corn meal agar) was prepared and amended with each test product as appropriate (see below). Amended agar was pipetted into 8.6 cm petri dishes. Plates were allowed to cool prior to the application of the pathogen. Due to the slow growing nature of the pathogen, two inoculation sites were included per plate and treated as replicates, with 4 replicates included per treatment overall. Plates were incubated at 23 ° C. and growth of the pathogen was measured at pre-set intervals. All experimental work was carried out using sterile techniques. An initial assessment was carried out 7 days post inoculation with the final assessment conducted at 14 days post inoculation. The average mycelial extension into amended agar from point of inoculation was recorded.

### Treatments—

Negative control: CMA (0.5% DMSO)
Eugenol 0.5%, 1% and 2% (all 0.5% DMSO in CMA)
(+/−)-exo,exo-2,3-Camphanediol 0.5%, 1% and 2% (all 0.5% DMSO in CMA)

Results—

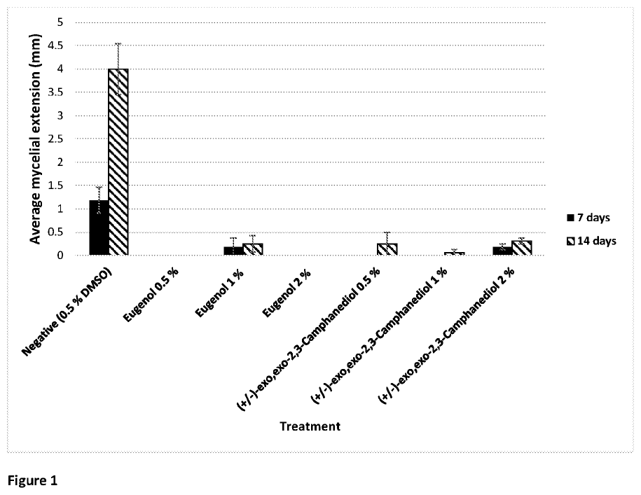

The average mycelial extension of Phytophthora infestans into amended CMA agar, measured 7 days and 14 days post inoculation, is shown below in FIG. 1. Growth, albeit slow, was recorded in the control treatment as expected, though was heavily reduced or absent altogether in both the Eugenol and (+/−)-exo,exo-2,3-Camphanediol treatments (at all concentrations). This inhibitory effect on growth appeared to hold true for both aerial and non-aerial mycelial growth. This was not unexpected given the generally volatile nature of many plant-based compounds, and potentially demonstrates a strong fumigant effect of the products tested.

1. A method for preventing or inhibiting the growth of and/or killing a plant pathogen of the genus Phytophthora on a plant or on a foodstuff derived from said plant, said method comprising administering to said plant or said foodstuff one or more compounds selected from:
(i) Formula I, or an agriculturally acceptable salt thereof, or solvate, racemic mixture, enantiomer, diastereomer or tautomer thereof: 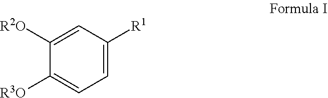
wherein:
R¹ is selected from the group consisting of H, substituted or unsubstituted C₁₋₆ alkyl, substituted or unsubstituted C₂₋₆ alkenyl, substituted or unsubstituted C₂₋₆ alkynyl, —C(═O)R⁴, and —(CH₂)ₙC(═O)R⁴;
R² and R³ are independently selected from the group consisting of H, substituted or unsubstituted C₁₋₁₀ alkyl, substituted or unsubstituted C₂₋₁₀ alkenyl, substituted or unsubstituted C₂₋₁₀ alkynyl, substituted or unsubstituted aryl ring, substituted or unsubstituted heterocyclic ring, —C(═O)R⁴, —(CH₂)ₙC(═O)R⁴, —C(═O)(CH₂)ₙR⁴, and —C(═O)NHR⁴;
R⁴ is selected from the group consisting of H, OR⁵, substituted or unsubstituted C₁₋₆ alkyl, substituted or unsubstituted C₂₋₆ alkenyl, substituted or unsubstituted C₂₋₆ alkynyl, substituted or unsubstituted aryl, and substituted or unsubstituted heterocyclic ring;
R⁵ is selected form the group consisting of H, substituted or unsubstituted C₁₋₆ alkyl, substituted or unsubstituted C₂₋₆ alkenyl, substituted or unsubstituted C₂₋₆ alkynyl, substituted or unsubstituted aryl, and substituted or unsubstituted heterocyclic ring; and
n is an integer from 1 to 6; or
(ii) Formula II, or an agriculturally acceptable salt thereof, or solvate, racemic mixture, enantiomer, diastereomer or tautomer thereof: 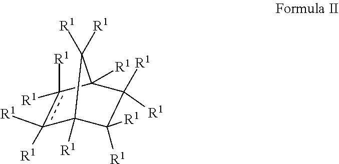
wherein:
each Ware independently selected from the group consisting of H, OR², substituted or unsubstituted C₁₋₆ alkyl, substituted or unsubstituted C₂₋₆ alkenyl, substituted or unsubstituted C₂₋₆ alkynyl, —C(═O)R³, —(CH₂)ₙC(═O)R³, —C(═O)(CH₂)ₙR³, and —C(═O)NHR³;
or any two R¹ attached to the same carbon form ═O;
or any two R¹ attached to the same carbon form a substituted or unsubstituted exocyclic C₂₋₆ alkenyl with the carbon atom to which they are attached;
R² is selected form the group consisting of H, substituted or unsubstituted C₁₋₆ alkyl, substituted or unsubstituted C₂₋₆ alkenyl, substituted or unsubstituted C₂₋₆ alkynyl, substituted or unsubstituted aryl, and substituted or unsubstituted heterocyclic ring;
R³ is selected from the group consisting of H, OR², substituted or unsubstituted C₁₋₆ alkyl, substituted or unsubstituted C₂₋₆ alkenyl, substituted or unsubstituted C₂₋₆ alkynyl, substituted or unsubstituted aryl, and substituted or unsubstituted heterocyclic ring;
---- represents an optional double bond; and
n is an integer from 1 to 6; or
(iii) Formula III, or an agriculturally acceptable salt thereof, or solvate, racemic mixture, enantiomer, diastereomer or tautomer thereof: 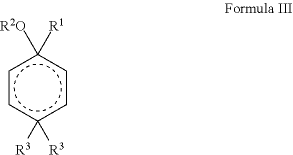
wherein:
R¹ is selected from the group consisting of H, substituted or unsubstituted C₁₋₆ alkyl, substituted or unsubstituted C₂₋₆ alkenyl, substituted or unsubstituted C₂₋₆ alkynyl, —C(═O)R⁴, and —(CH₂)ₙC(═O)R⁴;
or R¹ forms a substituted or unsubstituted exocyclic C₂₋₆ alkenyl with the carbon atom of the cyclohexyl ring to which it is attached and OR² is absent;
R² is selected from the group consisting of H, substituted or unsubstituted C₁₋₁₀ alkyl, substituted or unsubstituted C₂₋₁₀ alkenyl, substituted or unsubstituted C₂₋₁₀ alkynyl, substituted or unsubstituted aryl ring, substituted or unsubstituted heterocyclic ring, —C(═O)R⁴, —(CH₂)ₙC(═O)R⁴, —C(═O)(CH₂)ₙR⁴, and —C(═O)NHR⁴;
each R³ are independently selected from the group consisting of H, OR⁵, substituted or unsubstituted C₁₋₆ alkyl, substituted or unsubstituted C₂₋₆ alkenyl, substituted or unsubstituted C₂₋₆ alkynyl, —C(═O)R⁴, —(CH₂)ₙC(═O)R⁴, —C(═O)(CH₂)ₙR⁴, and —C(═O)NHR⁴;
or the two R³ together form an exocyclic substituted or unsubstituted C₂₋₆ alkenyl with the carbon atom to which they are attached;
R⁴ is selected from the group consisting of H, OR⁵, substituted or unsubstituted C₁₋₆ alkyl, substituted or unsubstituted C₂₋₆ alkenyl, substituted or unsubstituted C₂₋₆ alkynyl, substituted or unsubstituted aryl, and substituted or unsubstituted heterocyclic ring;
R⁵ is selected form the group consisting of H, substituted or unsubstituted C₁₋₆ alkyl, substituted or unsubstituted C₂₋₆ alkenyl, substituted or unsubstituted C₂₋₆ alkynyl, substituted or unsubstituted aryl, and substituted or unsubstituted heterocyclic ring;
---- represents an optional double bond between any two carbon atoms of the cyclohexyl ring;
where is a double bond including the carbon substituted by R¹ and OR², either R¹ or OR² is absent;
where is a double bond including the carbon substituted by R³ and R³, one R³ is absent; and
n is an integer from 1 to 6.

2. The method according to claim 1, wherein the method comprises administering to said plant or said foodstuff a compound of Formula I that is eugenol.

3. The method according to claim 1, wherein the method comprises administering to said plant or said foodstuff a compound of Formula II that is exo, exo-2,3-camphanediol.

4. The method according to claim 1, wherein the method comprises administering to said plant or said foodstuff a compound of Formula III that is terpineol.

5. A method for preventing or inhibiting the growth of and/or killing a plant pathogen of the genus Phytophthora on a plant or on a foodstuff derived from said plant, said method comprising administering to said plant or said foodstuff a liquid extract from a plant of the genus Artemisia.

6. The method according to claim 5, wherein said plant of the genus Artemisia is Artemisia vulgaris.

7. The method according to claim wherein said liquid extract is from a leaf and/or stem of said plant of the genus Artemisia.

8. The method according to claim 5, wherein said liquid extract comprises water.

9. A method according to claim 5, wherein said administering comprises spraying the compound or liquid extract onto said plant or said foodstuff derived from said plant.

10. The method according to claim 5, wherein the compound or liquid extract is administered to a plant in a field.

11. The method according to claim 5, wherein said plant is a crop plant, preferably a food crop plant.

12. The method according to claim 5, wherein the plant is a plant of the Solanaceae family.

13. The method according to claim 12, wherein the plant is a tomato plant or, preferably, a potato plant.

14. (canceled)

15. (canceled)

16. A composition comprising a compound and an agricultural spray adjuvant, wherein said compound is one or more of compounds of Formula I, II and III as structurally defined with claim 1.

17. A composition comprising a liquid extract from a plant of the genus Artemisia and an agricultural spray adjuvant.

18. composition according to claim 16, wherein said agricultural spray adjuvant comprises one or more of an oil, a surfactant, a sticker, and a penetrant.

19. The composition according to claim 17, wherein said agricultural spray adjuvant comprises one or more of an oil, a surfactant, a sticker, and a penetrant.
